(19) United States
(12) Patent Application Publication
(10) Pub. No.: US 2023/0089827 A1
(43) Pub. Date: Mar. 23, 2023

(54) METHOD FOR SELECTING STEREO PAIRS OF AERIAL OR SATELLITE IMAGES TO GENERATE ELEVATION DATA

(71) Applicant: AIRBUS DS GEO SA, Toulouse (FR)

(72) Inventors: Antoine CHEULA, Toulouse (FR); Benjamin CHRETIEN, Toulouse (FR); Emmanuel GARCIA, Toulouse (FR); Philippe NONIN, Toulouse (FR)

(21) Appl. No.: 17/933,653

(22) Filed: Sep. 20, 2022

(30) Foreign Application Priority Data
Sep. 22, 2021 (FR) 2109950

(51) Int. Cl. G06T 7/593; G06T 7/00; G06T 17/05

(52) U.S. Cl. CPC G06T 7/593; G06T 7/0002; G06T 17/05; G06T 2207/10032; G06T 2207/30168; G06T 2207/10012

(57) ABSTRACT

Method for selecting stereo pairs of satellite or aerial images to generate elevation data for an area of interest, the method being computer-implemented and including a phase of selecting eligible stereo pairs from an initial set of images representing the area of interest, followed by a phase of ranking the selected stereo pairs according to their quality. The method further includes a phase of defining N image clusters, where N is an integer greater than or equal to 2, each grouping images from the initial set according to a similarity criterion, and a phase of selecting the best stereo pairs per cluster on the basis of the ranking established during the ranking phase and on the fact that a pair belongs to a cluster if the two images of the pair belong to the cluster.

### CROSS-REFERENCE TO RELATED APPLICATIONS

This application is based on and claims priority under 35 U.S.C. § 119 to French Patent Application No. FR2109950, filed on Sep. 22, 2021, in the French Intellectual Property Office, the disclosure of which is incorporated by reference herein in its entirety.

### BACKGROUND

### Field

The present disclosure belongs to the fields of stereometry and photogrammetry, in particular aerial photogrammetry, and more particularly relates to a method for selecting stereo pairs of aerial or satellite images to generate elevation data such as digital elevation models (DEMs).

The present disclosure has a direct, but not exclusive, application in the generation of digital elevation models used in topography, 3D mapping, physical geography and more generally in various surface and terrain analyses.

### Brief Description of Related Developments

Aerial photogrammetry comprises all the techniques used to produce a representation of a large area, based on digital aerial photographs, mainly from cameras on board drones or aircraft, or from spatial images taken by one or more satellites.

The various photogrammetry techniques are based on the principle of stereoscopic observation and generally consist of using images of an area of interest, acquired from different viewpoints, in order to reconstruct the relief of said area from this difference in viewpoints.

This 3D reconstruction uses specific tools to generate digital elevation models from a determined number of stereo image pairs chosen from a set of captured images covering the area of interest. in full or in part.

However, the selection of stereo pairs can be a difficult, or even complex task, as it involves keeping only the most relevant pairs for the elevation computation. However, the greater the number of images in the set, the more complicated the selection of pairs becomes and the more likely it is that the selection of pairs will be insufficient to generate an elevation model to the desired accuracy.

Moreover, it is often preferable to limit the number of pairs used in order to conserve available computing capacity and reduce processing times.

Methods exist for selecting and minimising the number of stereo pairs chosen from a set of images in order to construct digital elevation models, 3D models, XYZ point clouds or any type of elevation data. Among the most advanced and notable research in this field is that published by Facciolo (Facciolo et al, 2017) and Becker (Becker et al, 2015).

Facciolo proposes an algorithm to compute a 3D reconstruction from a collection of satellite images of one and the same site. Based on the local affine approximation of the camera, this method is used to compute 3D models independently of the original image pairs and then align the models by 3D translations. Facciolo thus proposes a heuristic for selecting the best pairs of images from a large database, and concludes that the optimal result is obtained by keeping only a few well-chosen pairs from the set of all possible pairs.

This kind of method aims to sort all possible pairs according to their quality, and only processes the first elements of the resulting list. This is theoretically effective in selecting the most relevant pairs for any photogrammetry process, but does not use any appropriate algorithm to minimise the quantity of stereo pairs without ensuring sufficient coverage for the elevation computation.

### SUMMARY

It should be remembered that the selection of stereo pairs is the very first step in any standard stereo pipeline processed for generating elevation data. Elevation data must be understood to mean 3D models (triangulated irregular networks, textured or otherwise), digital elevation models, 3D vector models, or point clouds, etc.

The present disclosure aims to overcome the drawbacks of the prior art described hereinabove and proposes a heuristic for selecting stereo pairs allowing the best stereo pairs for performing elevation computations to be chosen from among all possible combinations of a set of satellite or aerial images. Once the best pairs have been identified, a minimisation method is used to eliminate redundancies from the selection.

To this end, the present disclosure relates to a method for selecting stereo pairs of satellite or aerial images to generate elevation data for an area of interest, said method being computer-implemented and comprising a phase of selecting eligible stereo pairs from an initial set of images representing the area of interest, followed by a phase of ranking the selected stereo pairs according to their quality. This method is noteworthy in that it further comprises a phase of defining N image clusters, where N is an integer greater than or equal to 2, each grouping images from the initial set according to a similarity criterion, and a phase of selecting, for each defined cluster, the best stereo pairs belonging to said cluster on the basis of the ranking established during the ranking phase and on the fact that a pair is considered to belong to a cluster if the two images of said pair belong to said cluster.

According to an advantageous embodiment, the similarity criterion for defining the image clusters corresponds to a pair of angles (θ, Φ), where θ is the incidence angle of the images and Φ is the azimuth viewing angle.

In a particularly advantageous manner, the cluster definition phase is carried out by a data clustering algorithm such as an affinity propagation algorithm.

In order to limit interventions by a human operator and further automate the method, the phase of selecting the best pairs per cluster consists of selecting the same number of pairs per cluster.

According to one embodiment, the best pairs selected during the phase of selecting the best pairs per cluster are aggregated into a final list. This allows this list to be saved so that it can be reused if necessary, in particular to refine the selection of the pairs by increasing the number of best pairs per cluster for example.

The present disclosure further relates to a photogrammetric method generating an elevation model of an area of interest from an initial set of images covering said area of interest, comprising a method for selecting stereo image pairs from said initial set of images as disclosed.

The present disclosure further relates to a system for computing elevation data for an area of interest from a set of satellite or aerial images, comprising computation means, such as one or more computers, configured to implement a stereo pair selection method as disclosed.

The present disclosure further relates to a computer program product that can be downloaded from a communication network and/or stored on a medium that can be read and/or executed by a microprocessor, comprising program code instructions for implementing a stereo pair selection method as disclosed.

The present disclosure further relates to a non-transitory terminal-readable storage medium storing a computer program comprising a set of instructions that can be executed by a computer or processor to implement a stereo pair selection method as disclosed.

One advantage of the present disclosure is that it improves the performance and robustness of the standard stereo pipeline for generating elevation data.

A further advantage of the present disclosure is that it improves the quality of the outputs generated by a standard stereo pipeline for generating elevation data.

A further advantage of the present disclosure is that it significantly reduces the processing cost of a standard stereo pipeline for generating elevation data.

The basic concepts of the disclosure have been set out hereinabove in their most basic form, and other details and features will more clearly emerge on reading the following description and with reference to the accompanying drawings, which give, by way of a non-limiting example, one embodiment of a stereo pair selection method in accordance with the principles of the disclosure.

### DESCRIPTION OF THE DRAWINGS

The figures are given for illustrative purposes only for a better understanding of the disclosure and do not limit the scope thereof. The different elements are represented diagrammatically. Identical or equivalent elements bear the same reference numerals in all figures.

The drawings thus illustrate, in:

FIG. 1: a simplified flowchart of a photogrammetric method of the prior art comprising a standard step of selecting stereo pairs for generating elevation data;

FIG. 2: an overview of a method for selecting stereo pairs from a set of images, according to the disclosure;

FIG. 3: a block diagram showing the implementation of the method according to one embodiment of the disclosure;

FIG. 4: a method programming flowchart giving a detailed view of the algorithm;

FIG. 5: a diagram of a satellite or aerial acquisition of a given area of interest;

FIG. 6: a diagram of the views and angles of the sun from a satellite or aerial acquisition;

FIG. 7: a diagram of the ground overlay of two satellite or aerial images showing an overlapping area;

FIG. 8: an example of grouped views positioned on a unit sphere and ranked into clusters;

FIG. 9: an example of selected stereo pair footprints without minimisation (41 pairs) in (a) and with minimisation on the same input dataset (16 pairs) in (b).

### DETAILED DESCRIPTION

It should be noted that certain technical elements well known to a person skilled in the art are described herein to avoid any insufficiency or ambiguity in the understanding of the present disclosure.

In the embodiment described hereinbelow, reference is made to a method for selecting stereo pairs of satellite or aerial images, mainly for the generation of elevation data for an area of interest. This non-limiting example is given for a better understanding of the disclosure and does not exclude the use of the principles of the disclosure in other image exploitation processes.

In the present description, the term “stereo pair” refers by contraction to a stereoscopic pair of images, i.e. a combination of two images of the same scene obtained by two different optical sensors from two different viewpoints. The term “image” refers to raw or processed data from an aerial or spatial imaging device comprising at least one optical sensor. Such an imaging device is, for example, a camera on board a reconnaissance aircraft or an observation satellite. Finally, the term “area of interest” refers to a large area on the surface of the Earth or another planet depending on the target application.

Prior to giving a detailed description of the present disclosure, the general principle of generating elevation information from stereo image pairs, commonly referred to as the “stereo pipeline”, is recalled hereinbelow.

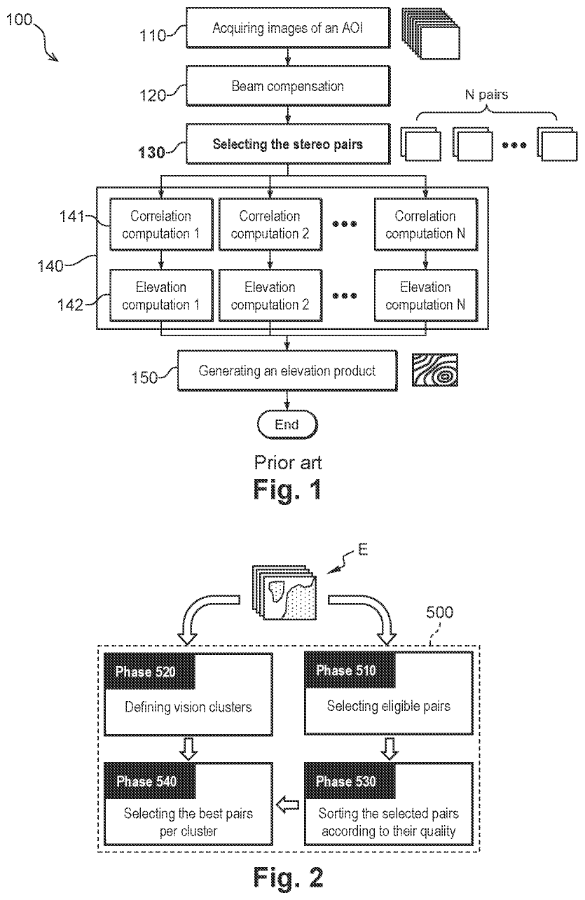

FIG. 1 shows a known method 100 for generating elevation information from a plurality of images representing a given area of interest, said method comprising:
a step 110 of acquiring images of an area of interest AOI;
a beam compensation step 120 for a better estimation of the sensor model of each image;
a step 130 of selecting, from among all the images, the stereo pairs that will be used in the elevation computation;
a step 140 of computing elevation information for each of the selected stereo pairs; and
a step 150 of generating an elevation product.

The image acquisition step 110 consists of capturing a plurality of images of the area of interest using at least two remote sensors from different viewpoints and/or using the same mobile sensor pointing towards the area of interest at different dates, and thus allows a set of stereo images of the area of interest to be constructed, which represent a certain number of 3D points from different viewpoints. The images will then be exploited to generate elevation information for the area of interest. This image acquisition step can of course be accompanied by a sorting of the images, taking into account various phenomena, in particular weather phenomena (cloud cover, snow cover and seasonal variations in vegetation, etc.), in order to only keep the high-quality images that provide highly accurate elevation information.

The beam compensation step 120 is well known in the prior art and generally consists of simultaneously refining the 3D coordinates defining the geometry of the area of interest, the relative motion parameters and the optical characteristics of the one or more cameras used to capture the images such as the camera positions or the navigation functions thereof. This compensation is carried out according to an optimisation criterion involving the projections of the images of all points. The beam compensation step is important because of the difference that inevitably exists between the parameters of the different cameras used, especially when each camera is on board a different satellite.

The stereo pair selection step 130 consists of identifying and retaining a subset of pairs from the set of all possible pairs in order to perform the elevation computations. The selected stereo pairs correspond, for example, to a determined number of best pairs from among the set of possible pairs. Thus, a qualitative ranking of all possible pairs can be established and only the N best pairs are selected, where N is a given integer.

The method 100 then continues with elevation computations performed for each of the selected pairs.

The elevation information computation step 140 consists of performing a correlation computation 141 (disparity map) followed by an elevation computation 142 for each selected stereo pair.

Finally, the elevation product generation step 150 consists of aggregating all the elevation data computed for all of the selected stereo pairs in order to obtain an elevation product which can be in the form of a 3D model, a digital elevation model, or a point cloud, etc.

In this context, the present disclosure proposes improving the process of selecting the stereo pairs used to increase the efficiency and accuracy of the elevation computations while reducing the cost thereof.

FIG. 2 shows the general principle for implementing a method 500 for selecting stereo pairs to generate elevation data according to the disclosure, said method taking place in four phases: a phase 510 of selecting eligible pairs; a phase 520 of defining vision clusters; a phase 530 of sorting the selected pairs according to their quality; and a phase 540 of selecting the best pairs per cluster.

The initial phases 510 of selecting eligible pairs and 520 of defining clusters are independent of one another and can be carried out in no preferred order, or even simultaneously, by directly exploiting all the images of a set of images E covering the area of interest studied. However, the intermediate phase 530 of qualitatively sorting the pairs must be carried out after phase 510. The final phase 540 of selecting the best pairs per cluster follows on from phases 520 and 530 and completes the pair selection method 500.

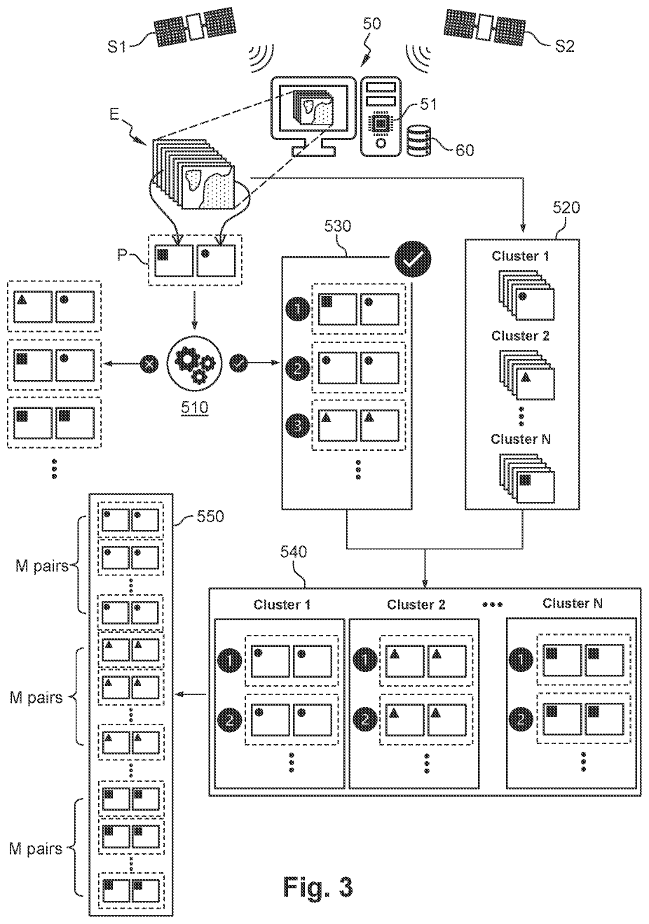

FIG. 3 gives a block diagram showing the implementation of the aforementioned phases of the method for selecting pairs to generate elevation data.

In this example, the selection method is implemented from a set E of images of an area of interest captured by two satellites S1 and S2.

In order to select the eligible stereo image pairs according to phase 510, each possible pair P, consisting of a combination of any two images from the set E, is subjected to a set of tests intended to determine whether said pair is eligible and must thus be selected, or ineligible in which case it will be discarded. The tests are tree-based and consist of checking a plurality of geometric criteria which will be described in detail in the description hereafter.

Any pair selected as a result of the tests, i.e. any pair meeting all the required criteria, is thus added to the list of eligible pairs. The eligible pairs are then ranked within this list according to their quality during the ranking phase 530.

In parallel to the stereo pair selection phase 510 and ranking phase 530, the phase 520 of defining clusters of images according to a given similarity criterion which, for example, can depend on one or more angles relative to the images, takes place.

With reference to FIG. 7, the chosen similarity criterion is a pair of angles (θ, Φ) where θ is the incidence angle and Φ is the azimuth viewing angle.

The incidence angle θ represents, from the target's viewpoint, the angle between the ground normal and the satellite's look direction, combining the pitch and roll angles.

This angle is equivalent, from the satellite's viewpoint, to the viewing angle and can thus be replaced thereby in the pair defining the similarity criterion.

During this phase, the images of the set E are distributed into different clusters according to the incidence and azimuth viewing angles thereof. In FIG. 3, each cluster corresponds to a different geometric pattern (circle, triangle, square) representing a certain value or range of values of the incidence and azimuth viewing angles.

It goes without saying that an image can perfectly well be found in several clusters at the same time.

Clusters are defined using a data clustering algorithm such as an affinity propagation algorithm. The number N of clusters can be defined automatically by the algorithm or configured manually by the user.

Based on the definition of the clusters and the ordered list of the stereo pairs obtained in phases 520 and 530 respectively, the pair selection method is completed by selecting the best pairs per cluster in phase 540. For a stereo pair to belong to a cluster, both of the images in said pair must belong to said cluster.

Thus, for a set E of n images, instead of using all possible stereo pairs, of which there are n*(n-1)/2 (a combination of 2 among n), only the best stereo pairs per cluster are used. Thus, the number of pairs used can be far lower than the total number of possible pairs.

For example, for a set of 100 images (a common number in satellite image sets), the inventors found that only 16 pairs, obtained by defining 4 clusters and selecting 4 pairs per cluster, are sufficient to obtain an accurate elevation computation, whereas the number of all possible pairs is 4,950 (=100*99/2).

Moreover, previous solutions propose reducing the list of pairs to be processed by selecting a given number of the best pairs from the list of all pairs, which does not guarantee the selection of the most relevant pairs for the elevation computation.

Thus, if the number of selected pairs must be fixed for any reason (for example the processing time), the method of the present disclosure would provide more relevant pairs than known methods because it is based on a clustering of the best pairs.

Thus, the reduction of the final list 550 of pairs according to the disclosure allows on the one hand the best stereo pairs to be selected and consequently pairs which are not relevant and which could generate noise in the output results to be discarded, and on the other hand avoids redundancies and guarantees acceptable processing performance levels.

It goes without saying that the pairs are not systematically selected from among all possible combinations, but that this selection takes into account the viewing frustum culling.

Viewing frustum culling is a level of hidden surface determination in which the viewing frustum is the representation of the volume visible to the camera. Naturally, objects outside this volume will not be visible, and thus not displayed. Objects straddling this volume will be clipped into smaller pieces in a process known as clipping, and pieces outside the volume will not be displayed.

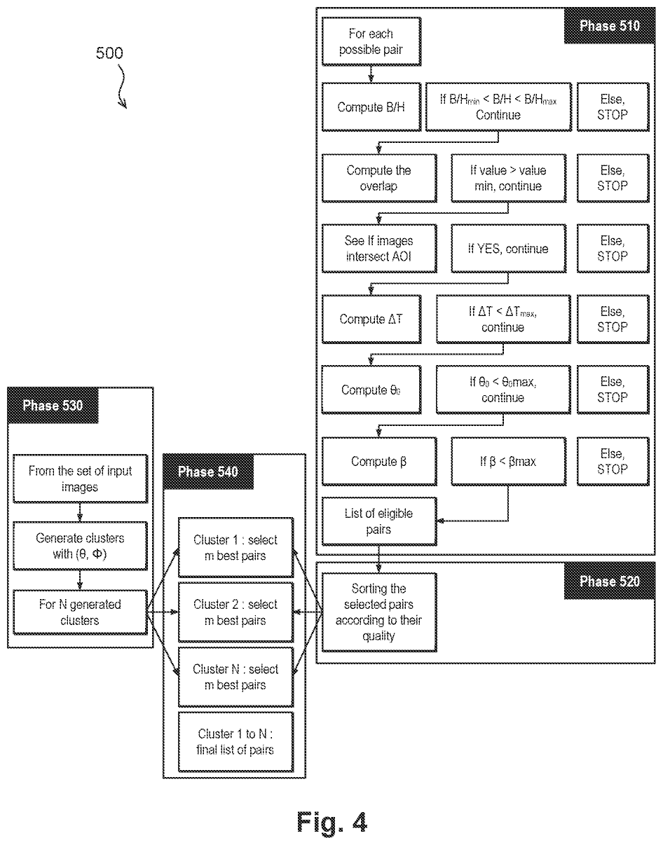

FIG. 4 shows in more detail the different phases of the method 500 for selecting pairs to generate elevation data, in order to better illustrate the implementation of the algorithm for carrying out said method.

The first part of the pair selection algorithm consists of identifying the eligible pairs, i.e. discarding pairs that will not be able to produce high-quality elevation information. Bad pairs are eliminated according to a heuristic based on users' experiences and the tree structure of several conditions.

According to the example embodiment shown, for each possible pair, i.e. for each combination of two overlapping images of the area of interest, the algorithm of phase 510 of selecting the eligible pairs operates as follows:
If the B/H ratio, where B is the base and H is the height, is between a minimum value and a maximum value provided by the user, continue.
If the overlap value exceeds a minimum value provided by the user, continue.
If the two overlapping images intersect the area of interest, continue.
If the time between the two acquisitions ΔT does not exceed a maximum value provided by the user, continue.
If the solar zenith angle θ₀ does not exceed a maximum value provided by the user, continue.
If the solar angle of the sensor β does not exceed a maximum value provided by the user, continue.
Add the pair to the list of eligible pairs.

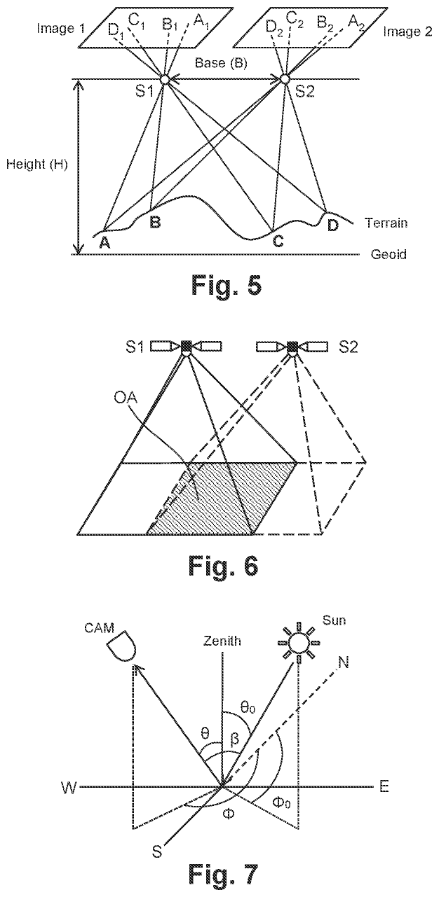

FIG. 5 illustrates the principle of stereo vision, which is the ability to extract elevation information from pairs of images, each of which comprises two images taken from different camera angles. With reference to this figure, it should be noted that the base B represents the distance between the two cameras during the acquisition of the images, in this case the two cameras are on board the satellites S1 and S2, and the height H corresponds to the average elevation of the cameras during the acquisition.

FIG. 6 shows an overlapping area OA between two images taken by the satellites S1 and S2, which can be defined as the area of one image that overlaps part of the other image.

FIG. 7 shows the angles concerned by the conditions of the eligible pair selection phase 510. The solar zenith angle θ₀ is the angle between the sun's rays and the vertical direction at the centre of the image, and the solar angle of the sensor β is the angle defined by the direction of incidence of the camera and the direction of incidence of the sun.

After the phase 510 of selecting the eligible pairs, said pairs are ranked according to their quality in phase 530 as shown in FIG. 4.

More specifically, after all of the irrelevant pairs have been discarded, all of the selected eligible pairs are sorted in order to assess which are the most relevant. A user-defined heuristic can be used for this purpose, which, for example, mainly takes into account a distance with an optimal B/H ratio and a minimum time difference Δt. The list of eligible pairs established in the previous phase 510 is then ranked in descending order of quality.

The cluster definition phase 520 is independent of the pair selection 510 and pair ranking 530 phases. The corresponding algorithm is also independent of the algorithms of phases 510 and 530. The purpose thereof is to aggregate the different viewpoints of the set of input images into clusters of similar orientation (or vision) (see angles θ and Φ in FIG. 7). The clusters are defined using an affinity propagation algorithm and by taking the incidence and azimuth viewing angles as a similarity criterion. The number of clusters is random and defined according to the specificities of the dataset. The user can choose whether to allow a view to belong to one or more clusters.

Finally, the last step of the algorithm consists of selecting the best pairs per cluster. For each vision cluster, the M best pairs are chosen, where M is an integer defined by the user. A pair belongs to a cluster if both of the images of the pair are included in said cluster.

The combination of the phases 520 of defining the clusters and 540 of selecting the best pairs per cluster advantageously allows the number of stereo pairs to be minimised, while ensuring that the area of interest is covered by the viewing angles, contrary to previous solutions which merely look to select the best stereo pairs, without taking into account the coverage of the viewing angles.

In the case of the present disclosure, the stereo pairs with irrelevant acquisition angles or acquisition time differences are eliminated in a known manner. However, phases 520 and 540 allow the best stereo pairs to be found for given incidence and azimuth viewing angles or a given range of said angles.

### EXAMPLE

For a dataset of 100 images of the area of interest, the number of possible stereo pairs is 4,950 (=100×99/2) as outlined hereinabove.

It can be assumed that, taking into account a restrictive user heuristic, only 100 pairs will be considered relevant (selection of eligible pairs) and will be ranked according to their quality. With the present disclosure, based on a cluster viewing system and a ranking of the pairs per cluster, it is possible to select only 16 pairs which are sufficient to obtain a high-quality elevation product.

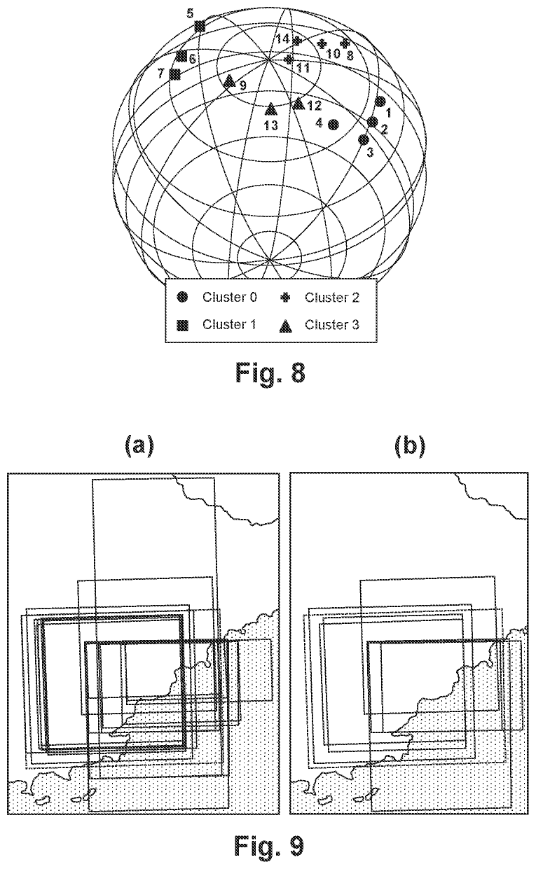

FIG. 8 shows a simplified example for defining 4 vision clusters for a set of 14 images. In this example, the image 4 can belong to both cluster 0 and cluster 3.

FIG. 9 shows an example of footprints on the ground, over the area of interest, of selected stereo pairs without minimisation (41 pairs) in (a) and with minimisation on the same input dataset (16 pairs) in (b), and thus shows the removal of all irrelevant, essentially redundant, pairs in the elevation computation.

It is clear from the present description that certain steps can be added to the stereo pair selection method according to the disclosure, while still remaining within the scope of the disclosure.

What is claimed is:

1. A method for selecting stereo pairs of satellite or aerial images to generate elevation data for an area of interest, said method being computer-implemented and comprising a phase of selecting eligible stereo pairs from an initial set of images representing the area of interest, followed by a phase of ranking the selected stereo pairs according to their quality, said method being characterised in that it further comprises a phase of defining N image clusters, where N is an integer greater than or equal to 2, each grouping images from the initial set according to a similarity criterion, and a phase of selecting the best stereo pairs per cluster on the basis of the ranking established during the ranking phase and on the fact that a pair belongs to a cluster if the two images of said pair belong to said cluster.

2. The method according to claim 1, wherein the similarity criterion corresponds to a pair of angles (θ, Φ), where θ is the incidence angle of the images and Φ is the azimuth viewing angle.

3. The method according to claim 1, wherein the cluster definition phase is carried out by a data clustering algorithm such as an affinity propagation algorithm.

4. The method according to claim 1, wherein the phase of selecting the best pairs per cluster consists of selecting the same number of pairs per cluster.

5. The method according to claim 1, wherein the best pairs selected during the phase of selecting the best pairs per cluster are aggregated into a final list.

6. A photogrammetric method generating an elevation model of an area of interest from an initial set of images covering said area of interest, characterised in that it comprises a method according to one of claim 1.

7. A system for computing elevation data for an area of interest from a set of satellite or aerial images, characterised in that it comprises computing means configured to implement a method according to one of claim 1.

8. A computer program product available for download from a communication network and/or stored on a medium that can be read and/or executed by a microprocessor, characterised in that it comprises program code instructions for executing a method according to one of claim 1, when it is executed on a computer.

9. A non-transitory terminal-readable storage medium storing a computer program comprising a set of instructions that can be executed by a computer or processor to implement a method according to one of claim 1.
